(19) United States
(12) Patent Application Publication
(10) Pub. No.: US 2025/0303819 A1
(43) Pub. Date: Oct. 2, 2025

(54) Outside Air Introduction Device and HVAC System for Vehicle Including the Same

(71) Applicant: Hyundai Motor Company, Seoul (KR)

(72) Inventors: Kwang Ok Han, Seoul (KR); Myung Hoe Kim, Seoul (KR); Yu Yeon Kang, Seoul (KR); Kwang Woon Cho, Yongin-Si (KR); Hyo Geun Oh, Cheongju-Si (KR); Jae Chun Ryu, Daejeon (KR); Tae Yong Park, Daejeon (KR); Jeong Sik Shin, Daejeon (KR)

(21) Appl. No.: 18/882,867

(22) Filed: Sep. 12, 2024

(30) Foreign Application Priority Data
Mar. 27, 2024 (KR) 10-2024-0042056

(51) Int. Cl. B60H 1/00; B60H 3/06

(52) U.S. Cl. CPC B60H 1/00849; B60H 3/0608

(57) ABSTRACT

An apparatus for introducing outside air is introduced. The apparatus may comprise a duct-shaped body, at least one filter member configured to filter foreign substances or moisture from the outside air, wherein the at least one filter is disposed in the duct-shaped body, and a discharger configured to discharge the filtered foreign substances or moisture, wherein the discharger is disposed in a lower portion of the duct-shaped body, and wherein the lower portion is closer to the ground.

### CROSS-REFERENCE TO RELATED APPLICATION(S)

This application claims benefit of priority to Korean Patent Application No. 10-2024-0042056 filed on Mar. 27, 2024 in the Korean Intellectual Property Office, the disclosure of which is incorporated herein by reference in its entirety.

### TECHNICAL FIELD

The present disclosure relates to an outside air introduction device capable of filtering and discharging foreign substances or moisture flowing in with outside air, and an air-conditioning system, i.e., a heating, ventilation, and air-conditioning (HVAC) system, for a vehicle including the same.

### BACKGROUND

An air-conditioning system (i.e., a HVAC system) for vehicles is a system for providing cooling, heating, and ventilation to the interior of vehicles. The air-conditioning system intakes outside air through an outside air introduction device or circulates indoor air to bring outside air and/or the indoor air into the interior of vehicles.

For example, the HVAC system may be mounted in an upper portion, that is, the roof, of the vehicle due to limitations in installation space and to ensure smooth utilization of the system. In this case, dust, foreign substances, moisture, such as rainwater, etc. may be inevitably introduced into the outside air introduction device placed on the outside of the vehicle. To solve this problem, the outside air introduction device includes at least one filter member.

As a result, outside air flowing into the outside air introduction device may pass through a filter member, and large dust particles, foreign substances, moisture, such as rainwater, etc. included in the outside air may not pass through the filter member and may be blocked. However, as filtered foreign substances or moisture are accumulated in the outside air introduction device as is, noise may occur or the performance of the apparatus may deteriorate.

This background information is provided only for better understanding of the present disclosure and does not constitute prior art.

### SUMMARY

According to the present disclosure, an apparatus for introducing outside air, the apparatus may comprise a duct-shaped body, at least one filter member configured to filter foreign substances or moisture from the outside air, wherein the at least one filter is disposed in the duct-shaped body, and a discharger configured to discharge the filtered foreign substances or moisture, wherein the discharger is disposed in a lower portion of the duct-shaped body, and wherein the lower portion is closer to the ground.

The apparatus, wherein the duct-shaped body may comprise an inlet disposed on one side to allow outside air to flow in, wherein an inlet grill is mounted on the inlet, an outlet disposed on another side, and at least one partition dividing an internal space into a plurality of regions.

The apparatus, wherein a first inclined surface is formed on a first surface of the duct-shaped body, and the inlet is formed on the first inclined surface.

The apparatus, wherein the at least one partition has a curved cross-section that is curved at least once.

The apparatus, wherein a through-hole is formed in the middle of the at least one partition, the filter member includes at least a first filter member, and the first filter member is mounted in the through-hole.

The apparatus, wherein the through-hole may comprise a protrusion, and wherein the protrusion is formed by curving at least one edge of the through-hole.

The apparatus, wherein a second inclined surface is formed on a second surface of the duct-shaped body, the discharger is connected to an end of the second inclined surface, and foreign substances or moisture filtered by the first filter member are guided to the discharger along the second inclined surface or the at least one partition and discharged to an outside of the duct-shaped body.

The apparatus, wherein the filter member further may comprise a second filter member, and the second filter member is mounted on the outlet.

The apparatus, wherein one end of the at least one partition is spaced apart from a surface of the duct-shaped body or the discharger to form a gap between the at least one partition and the surface of the duct-shaped body or the discharger, and foreign substances or moisture filtered by the second filter member are guided to the discharger by the gap and discharged to an outside of the duct-shaped body.

The apparatus, wherein a guide is formed in a portion of the at least one partition, and wherein a thickness of the guide is incrementally increased from one end of the guide to another end of the guide.

The apparatus, wherein the guide has a triangular cross-section, and wherein the triangular cross-section has a shape of a triangle that is not a right triangle.

The apparatus, wherein the second filter member is configured to filter foreign substances or moisture that are smaller in size than those filtered by the first filter member.

The apparatus, wherein the first filter member may comprise a mesh filter, and the second filter member may comprise a particle filter.

The apparatus, wherein the discharger may comprise a collection portion having an upper portion and a lower portion, wherein the upper portion has a wider shape than the lower portion, a discharge port at the lower portion of the collection portion, and a discharge pipe connected to the discharge port.

The apparatus, wherein the apparatus is connected to a mixing chamber configured to provide a space for mixing the outside air and circulating indoor air.

The apparatus, wherein the apparatus is provided as a pair, wherein a first one of the pair is connected to front of the mixing chamber and a second one of the pair is connected to rear of the mixing chamber, and a circulation duct is connected to a portion of the mixing chamber, wherein the circulation duct is configured to allow the indoor air to flow into the mixing chamber.

The apparatus, wherein a condenser is connected to one side of the mixing chamber, an evaporator is connected to another side of the mixing chamber, and blowers are disposed downstream of both the condenser and the evaporator.

The apparatus, wherein each of the blowers interfaces with a pair of air supply portions, and wherein each of the air supply portions may comprise a first air supply duct, a second air supply duct branched from the first air supply duct, and a door disposed between the first air supply duct and the second air supply duct.

The apparatus, wherein one of the first air supply ducts adjacent to the condenser and another of the first air supply ducts adjacent to the evaporator are connected to each other and integrated.

The apparatus, wherein the discharger is configured to discharge the filtered foreign substances or moisture to reduce noise associated with an operation of the apparatus.

### BRIEF DESCRIPTION OF DRAWINGS

The above and other examples, features, and advantages of the present disclosure will be more clearly understood from the following detailed description, taken in conjunction with the accompanying drawings, in which:

FIG. 1 shows an example of an air-conditioning system for a vehicle to which an outside air introduction apparatus according to the present disclosure is applied;

FIG. 2 shows an example of a cross-sectional view taken along line A-A′ of FIG. 1; and

FIG. 3 shows an example of an outside air introduction device according to the present disclosure.

### DETAILED DESCRIPTION

In this specification, vehicles refer to a variety of vehicles that move transported objects, such as people, animals, or goods, from a starting point to a destination. These vehicles are not limited to vehicles that run on roads or tracks.

It will be understood that, although the terms “first,” “second,” etc. may be used herein to describe various elements, these elements should not be limited by these terms. These terms are only used to distinguish one element from another.

The terms “front,” “rear,” “left,” “right,” “upper,” “lower,” and the like are defined based on a vehicle or vehicle body.

For example, large vehicles, such as buses, having a great body length and a large interior space, may use large-capacity air conditioners. It may be difficult to install air-conditioning systems with the large-capacity air conditioners inside vehicles or engine rooms. In this case, at least some of air-conditioning systems may be installed on the roof of vehicles.

Meanwhile, autonomous vehicles that may detect the surrounding environment and operate autonomously without human intervention have been introduced. In these autonomous vehicles, there may be no driver in the front seat or the front seat may face the rear. To this end, space and convenience inside vehicles should increase, and accordingly, installing an air-conditioning system on the roof of vehicles may be considered.

However, as mentioned above, if the air-conditioning system of vehicles is mounted on the roof, dust, foreign substances, moisture, such as rainwater, etc. may be introduced into the outside air introduction device, and furthermore, the filtered foreign substances or moisture may accumulate within the outside air introduction device as is.

Accordingly, the present disclosure proposes an outside air introduction device configured to filter and discharge foreign substances or moisture introduced with outside air, and an air-conditioning system for a vehicle including the same.

Hereinafter, the present disclosure are described in detail through drawings. When adding reference numerals to components in each drawing, it should be noted that identical components are given the same reference numerals as much as possible although they are shown in different drawings.

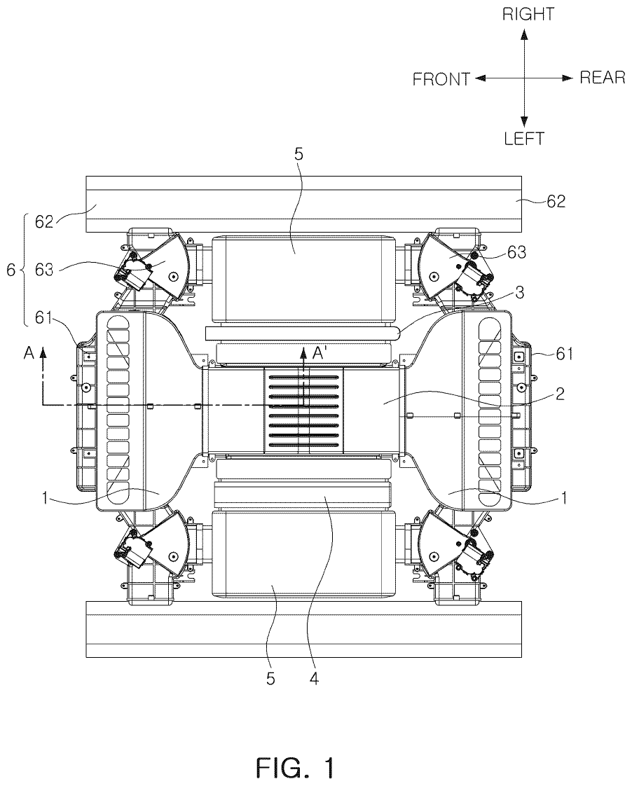

FIG. 1 shows an example of an air-conditioning system for a vehicle to which an outside air introduction device according to the present disclosure is applied.

The air-conditioning system for a vehicle to which the outside air introduction device according to the present disclosure is applied may be mounted on the roof of the vehicle.

The air-conditioning system may include a pair of outside air introduction devices 1, a mixing chamber 2, a condenser 3, an evaporator 4, and a pair of blowers 5. A detailed configuration and operation of the outside air introduction device is described below.

The mixing chamber 2 may provide a space for mixing outside air introduced from the outside air introduction device 1 and indoor air circulated from the interior of the vehicle. Outside air introduction devices may be connected to the front and rear of the mixing chamber, respectively.

Accordingly, if the vehicle moves forward, outside air may be introduced from the outside air introduction device 1 located in front of the mixing chamber 2, while if the vehicle moves backward, outside air may be introduced from the outside air introduction device located at the rear of the mixing chamber, selectively.

However, the introduction of outside air is not necessarily limited thereto, and outside air may be introduced simultaneously from the front outside air introduction device 1 and the rear outside air introduction device 1, or a portion of outside air introduced from one side outside air introduction device may be discharged to the outer side outside air introduction device.

A circulation duct 9 may be connected to a lower portion of the mixing chamber 2, so that air from the interior of the vehicle may flow into the mixing chamber. Accordingly, mixed air of outside air and indoor air may be formed in the mixing chamber.

The condenser 3 may be connected to one of the left and right sides of the mixing chamber 2 and the evaporator 4 may be connected to the other side.

In the condenser 3, a refrigerant flowing inside the condenser and mixed air passing through the condenser from the mixing chamber 2 may exchange heat with each other, thereby condensing refrigerant and raising the temperature of the mixed air. As a result, the air-conditioning system may provide hot air to the interior of the vehicle to perform heating.

In the evaporator 4, the refrigerant flowing inside the evaporator and mixed air passing through the evaporator from the mixing chamber 2 may exchange heat with each other, thereby removing heat from the mixed air, while evaporating the refrigerant, to cool the mixed air. As a result, the air-conditioning system may supply cold air to the interior of the vehicle to achieve cooling.

A pair of blowers 5 may be disposed downstream of the condenser 3 and downstream of the evaporator 4, respectively. Each blower intakes mixed air from the mixing chamber 2 and discharges intaken air to the outside of the air-conditioning system, for example, into the interior of the vehicle.

Each of the blowers 5 may be configured as an axial fan driven by a motor, but is not limited thereto and each of the blowers 5 may be configured as a propeller-type fan driven by a motor. In addition or alternative, the blowers may be integrated with the condenser 3 or the evaporator 4, respectively, to be modularized.

Accordingly, each blower 5 in the air-conditioning system for a vehicle may function as an intake unit allowing indoor air to flow into the air-conditioning system and/or as a blowing unit discharging mixed air to the room.

Since the detailed configuration, function, and operational relationship of the condenser 3, the evaporator 4, the blower 5, and related parts described above are already widely known, a detailed description thereof is omitted in this specification.

In addition or alternative, the air-conditioning system may include a plurality of air supply portions 6 communicating or interfacing with the blowers 5, respectively. For example, the pair of air supply portions may be arranged on both sides of a single blower.

Each air supply portion 6 may include a first air supply duct 61, a second air supply duct 62 branched from the first air supply duct, and a door 63 disposed between the first air supply duct 61 and the second air supply duct, that is, at a branch point.

For example, the first air supply duct 61 may supply hot air and/or cold air to a location relatively adjacent to the location of the air-conditioning system in the interior of the vehicle, and the second air supply duct 62 may supply hot air and/or cold air from the air-conditioning system in the interior of the vehicle to a relatively distant location.

Specifically, the first air supply duct 61 may discharge hot air and/or cold air toward a first row of seats, and the second air supply duct 62 may discharge hot air and/or cold air toward a second or third row of seats.

In this case, by adjusting the angle of the door 63, air may be blown to at least one of the first air supply duct 61 and the second air supply duct 62.

Alternatively or additionally, the first air supply duct 61 may supply hot air and/or cold air to the interior of the vehicle, and the second air supply duct 62 may be configured to discharge the inside air together with introduced outside air to the outside of the vehicle when blowing is not used. Thereby, ventilation of the interior of the vehicle may be achieved.

Selectively, the first air supply duct 61 of the blower 5 adjacent to the condenser 3 and the first air supply duct 61 of the blower 5 adjacent to the evaporator 4 may be connected and integrated with each other. The integrated first air supply duct may be supplied with one of hot air from the blower adjacent to the condenser, cold air of the blower adjacent to the evaporator, and a mixture of hot air of the blower adjacent to the condenser and cold air of the blower adjacent to the evaporator. Accordingly, the air-conditioning system may more easily control the temperature of the interior of the vehicle.

In addition or alternative, the air-conditioning system may further include a casing (not shown) accommodating and protecting the components described above, that is, the outside air introduction device 1, the mixing chamber 2, the condenser 3, the evaporator 4, the blower 5, the air supply portion 6, etc.

The front and back of the casing may be opened to allow smooth introduction of outside air. In addition or alternative, the casing may have a hole formed in the lower portion or a lower surface thereof may be opened to discharge foreign substances (e.g., dust, pollen, pet dander, mold spores, bacteria, viruses, smoke particles, chemical fumes, dust mites, fibers and lint, human skin flakes, insect parts, asbestos fibers, lead dust, pollutants, etc.) or moisture that fall from the outside air introduction device 1. Selectively, if a hole is provided, a discharge tube or discharge duct guiding foreign substances or moisture, etc. to the outside of the vehicle may be connected to the hole of the casing.

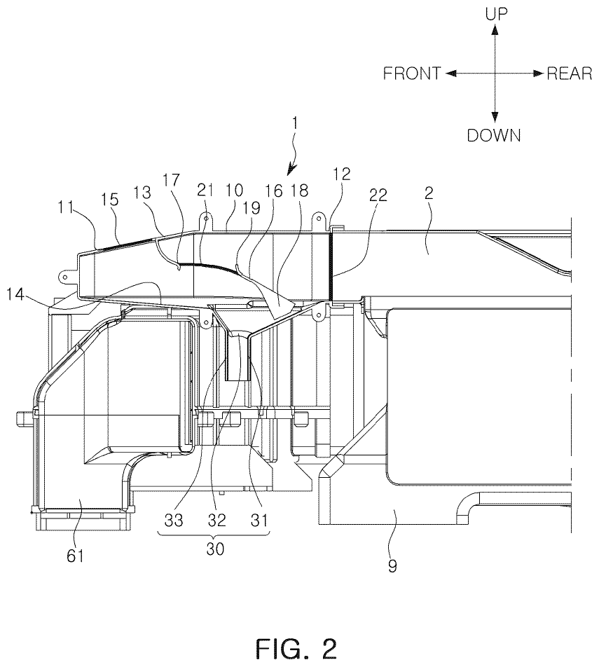

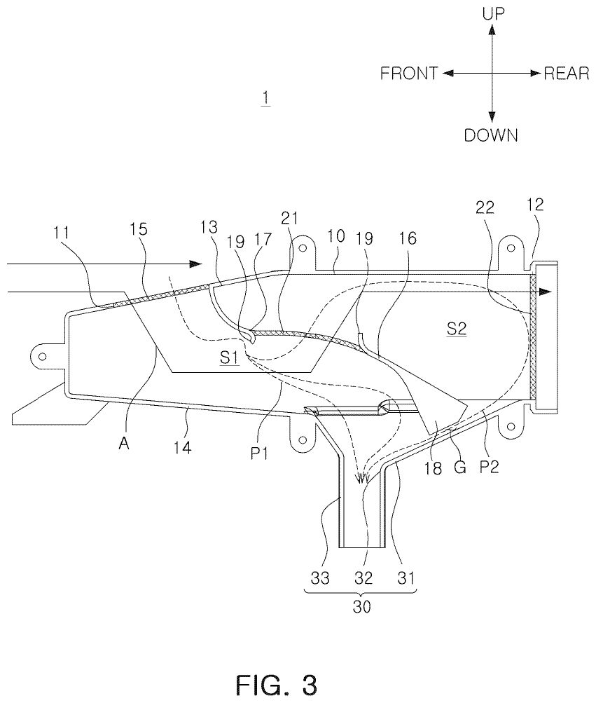

FIG. 2 shows an example of a cross-sectional view taken along line A-A′ of FIG. 1, and FIG. 3 shows an example of an outside air introduction device according to the present disclosure.

The outside air introduction devices 1 according to the present disclosure may be arranged at the front and the rear of the mixing chamber 2, respectively, to communicate with the inside of the mixing chamber 2. In the mixing chamber, outside air introduced into the outside air introduction device from the outside of the vehicle and passing through the outside air introduction device and indoor air circulating from the interior of the vehicle may be mixed to form mixed air.

The outside air introduction device 1 according to the present disclosure may include a body 10, filter members 21 and 22, and a discharge unit 30.

The body 10 may be formed as a duct-shaped member having an internal space. A duct-shaped body refers to a structure designed to direct the flow of air, gases, or fluids from one point to another. It may be characterized by its elongated, cylindrical or rectangular form, with a hollow interior that allows for the passage of the medium it is meant to convey. The body may be formed of a rigid material, such as metal or plastic, but the material is not particularly limited.

An inlet 11 through which outside air flows in may be disposed on one side of the body 10 in a front-rear direction, and an outlet 12 provided in communication with the mixing chamber 2 may be disposed on the other side. Of course, the inlet and outlet communicate with the internal space of the body. In addition or alternative, the discharge unit 30 may be disposed in a lower portion of the body.

For example, a first inclined surface 13 may be formed on one upper side of the body 10, and the inlet 11 having a predetermined size may be formed in the first inclined surface. The first inclined surface may be inclined gently at an angle less than about 45 degrees with respect to a horizontal plane, but is not limited thereto.

In this manner, the inlet 11 may be formed on the first inclined surface 13 and disposed to be inclined gently, so that outside air may easily flow into the inlet, but light foreign substances or rainwater may not be introduced into the inlet and pass through the inlet along with an air current flowing around the body due to movement of the vehicle.

An inlet grill 15 may be mounted on the inlet 11. As a result, fresh outside air may pass through the inlet grill and flow into the internal space of the body, while foreign substances having a large size (e.g., 10 microns or larger) or large volume (e.g., 1 grams or larger) cannot pass through the inlet grill.

Selectively, a second inclined surface 14 may be formed on a lower surface of the body 10, and the discharge unit 30 may be connected to a lower end of the second inclined surface. The second inclined surface may be inclined gently at an angle less than about 45 degrees with respect to the horizontal plane, but is not limited thereto.

In addition or alternative, the body 10 may be formed so that the width thereof in a horizontal direction gradually decreases from one side in which the inlet 11 is disposed, to the other side in which the outlet 12 is disposed.

The body 10 may include at least one partition 16 dividing the internal space into a plurality of regions. The partition may divide the internal space of the body into at least two regions, for example, a first region S1 adjacent to the inlet 11 and a second region S2 adjacent to the outlet 12.

The partition 16 may be formed of a plate material and have a curved cross-section that is curved at least once. FIGS. 2 and 3 show a curved cross-section that is curved twice, that is, an approximately S-shaped cross-section, but the cross-sectional shape of the partition is not limited thereto.

As the partition 16 has a curved cross-section, foreign substances or moisture introduced into the first region may be guided toward the discharge unit 30 located in a lower portion of the body 10 without flow resistance.

The partition 16 may contact and be fixed to the upper surface, the first inclined surface 13, and both side surfaces of the body 10. In other words, a lower end of the partition may be installed to be spaced apart without contacting the body or the discharge unit 30 to form a gap G with the body or the discharge unit. In addition or alternative, a through-hole 17 may be formed in the middle of the partition.

Accordingly, the first region S1 and the second region S2 within the body 10 may communicate or interface with each other through the through-hole 17 and the gap G.

Selectively, a guide 18 having a thickness gradually increasing toward a lower end may be formed in a lower portion of the partition 16. Thereby, the guide may have an approximately triangular cross-section.

The lower surface of the guide 18 may be aligned with the lower end of the partition 16, so that the guide may form a gap G having a predetermined length in the thickness direction of the partition between the guide and the body 10 or the discharge unit 30.

In addition or alternative, in the triangular cross-section of the guide, external angles of both inclined planes with respect to the lower surface may be formed as obtuse angles (e.g., angles greater than 90 degrees and less than 180 degrees), respectively. In other words, the triangular cross-section of the guide is not a right triangle (e.g., acute triangle or obtuse triangle). Accordingly, the guide may prevent the accumulation of small foreign substances, such as dust, or accumulation of moisture, in the lower portion of the partition.

In addition or alternative, selectively, the through-hole 17 of the partition 16 may be provided with a protrusion 19 in the form of a so-called burr (e.g., a rough or raised edge that forms on a material, typically metal or plastic, after it has been cut, drilled, or otherwise machined), which is formed by bending an edge of at least one side of the through-hole. FIGS. 2 and 3 show a pair of protrusions 19, one of which protrudes toward the first region S1 and the other protrudes toward the second region S2. However, the shape and number of the protrusions, an arrangement, a protrusion direction, etc. are not limited thereto.

By providing the protrusion 19 in the through-hole 17, the filtering effect of foreign substances or moisture may be enhanced and the foreign substances or moisture may be guided toward the discharge unit 30 or the gap G located in the lower portion of the body 10.

The filter member (e.g., fiberglass filters, pleated filters, electrostatic filters, high-efficiency particulate air (HEPA) filters, activated carbon filters, washable/reusable filters, UV light filters, media filters, bag filters, panel filters, etc.) may include at least a first filter member 21. The first filter member may be mounted in the through-hole 17 formed in the partition 16.

In addition or alternative, the filter member may further include a second filter member 22. The second filter member may be mounted on the outlet 12 of the body 10.

Selectively, if the body 10 is provided with a plurality of partitions 16, a through-hole may be formed in each partition and an additional filter member may be installed. However, the present disclosure is not limited thereto, and the additional filter member may be omitted.

For example, a mesh filter may be used as the first filter member 21, and a particle filter filtering particles having a size of approximately 2.5 μm or more may be used as the second filter member 22. In other words, the second filter member may filter smaller-sized foreign substances or moisture, etc. than the first filter member.

In a case in which a flow path A of outside air is formed from the inlet 11 of the body 10 to the first region S1, the through-hole 17 of the partition 16, the second region S2, and the outlet 12 of the body, if the plurality of filter members 21 and 22 are arranged, it is possible to filter out smaller-sized foreign substances or moisture, etc. toward the downstream of the flow path A of outside air.

For reference, in FIG. 3, the flow path A of outside air is indicated by the solid arrows.

Through such filtering, outside air that is as fresh as possible and free of foreign substances or moisture may flow through the outside air introduction device 1 of the present disclosure to the subsequent components of the air-conditioning system, such as the mixing chamber 2.

The discharge unit 30 may be disposed in the lowermost portion of the body 10 and may discharge foreign substances or moisture filtered by the plurality of filter members 21 and 22. The discharge unit may include a collection portion 31 having a shape of a wide upper portion and a narrow lower portion and having a discharge port 32 at a lower end thereof and a discharge pipe 33 connected to the discharge port of the collection portion.

The collection portion 31 may have an upper end connected to a lower end of a sidewall of the body 10 or a lower surface of the body, and at least one inner surface thereof may be formed to be inclined, so that the inner surface of the collection portion may have a shape having a wide upper portion and a narrow lower portion, that is, a so-called funnel shape.

The inclined inner surface of the collection portion may form a discharge path for foreign substances or moisture.

Specifically, foreign substances or moisture filtered by the first filter member 21 disposed in the through-hole 17 of the partition 16 may pass through the first region S1 in the body 10 and may be moved along the second inclined surface 14 formed in the lower surface of the body or the partition to be guided to the discharge pipe 33 by the inclined inner surface of the collection portion 31 so as to be discharged to the outside of the body. In this manner, the path within the first region may be referred to as a first discharge path P1.

In addition or alternative, foreign substances or moisture filtered by the second filter member 22 of the outlet 12 may pass through the second region S2 in the body 10 and may be moved along the second inclined surface 14 formed in the lower surface of the body or the partition 16 to be guided to the discharge pipe by the gap G formed between the inclined inner surface of the collection portion 31 and the lower end of the partition (the lower surface of the guide) so as to be discharged to the outside of the body. In this manner, the path configured by the second region and the gap may be referred to as a second discharge path P2.

For reference, in FIG. 3, the first discharge path P1 and the second discharge path P2 are indicated by the dotted arrows.

Foreign substances or moisture collected on the inclined inner surface of the collection portion 31 may pass through the discharge port 32 and may be discharged to the outside of the body 10 through the discharge pipe 33 connected to a lower portion of the discharge port. The discharge pipe 33 may be formed of a flexible material that is easily deformable, but is not limited thereto. That is, a straight pipe formed of a sturdy material may be adopted.

Accordingly, foreign substances or moisture filtered within the body 10 may be discharged to the outside of the body by gravity through the discharge unit 30, that is, the discharge port 32 of the collection portion 31 and the discharge pipe 33. Foreign substances or moisture discharged to the outside of the body may freely fall inside the casing of the air-conditioning system or may be discharged to the outside of the vehicle if there is no casing.

An example of the present disclosure is to provide an outside air introduction device capable of filtering and discharging foreign substances or moisture introduced together with outside air, and an air-conditioning system for a vehicle including the same.

According to an example of the present disclosure, an outside air introduction device includes: a duct-shaped body; at least one filter member disposed in the body; and a discharge unit disposed in a lower portion of the body and discharging foreign substances or moisture filtered by the filter member.

The body may include: an inlet disposed on one side to allow outside air to flow in; an outlet disposed on the other side; and at least one partition dividing an internal space into a plurality of regions, wherein an inlet grill is mounted on the inlet.

A first inclined surface may be formed on one upper side of the body, and the inlet may be formed on the first inclined surface.

The partition may have a curved cross-section that is curved at least once.

A through-hole may be formed in the middle of the partition, the filter member may include at least a first filter member, and the first filter member may be mounted in the through-hole.

The through-hole may include a protrusion formed as at least one edge of the through-hole is curved.

A second inclined surface may be formed on a lower surface of the body, the discharge unit may be connected to a lower end of the second inclined surface, and foreign substances or moisture filtered by the first filter member may move along the second inclined surface or the partition and may be discharged to the outside of the body through the discharge unit.

The filter member may further include a second filter member, and the second filter member may be mounted on the outlet.

The partition may be installed so that a lower end thereof is spaced apart from a lower surface of the body or the discharge unit to form a gap formed between the partition and the lower surface of the body or the discharge unit, and foreign substances or moisture filtered by the second filter member may be guided to the discharge unit by the gap and discharged to the outside of the body.

A guide having a thickness gradually increasing toward a lower end may be formed in a lower portion of the partition.

The guide may have a triangular cross-section, and in the triangular cross-section, external angles of both inclined planes with respect to a lower surface may be formed as obtuse angles, respectively.

The second filter member may be capable of filtering smaller-sized foreign substances or moisture than the first filter member.

The first filter member may include a mesh filter, and the second filter member may include a particle filter.

The discharge unit may include: a collection portion having a shape of a wide upper portion and a narrow lower portion and having a discharge port at a lower end thereof; and a discharge pipe connected to the discharge port.

According to another example of the present disclosure, an air-conditioning system for a vehicle includes: a mixing chamber providing a space for mixing outside air and circulating indoor air; and the outside air introduction device described above, connected to the mixing chamber.

The outside air introduction device may be provided as a pair, the outside air introduction devices may be connected to front and rear of the mixing chamber, respectively, and a circulation duct allowing the indoor air to flow into the mixing chamber may be connected to a lower portion of the mixing chamber.

A condenser may be connected to one of left and right sides of the mixing chamber, an evaporator may be connected to the other side, and a blower may be disposed each of downstream of the condenser and downstream of the evaporator.

An air supply portion may communicate with the blower, and the air supply portion may include: a first air supply duct, a second air supply duct branched from the first air supply duct, and a door disposed between the first air supply duct and the second air supply duct.

The first air supply duct adjacent to the condenser and the first air supply duct adjacent to the evaporator may be connected to each other and integrated.

As described above, according to an example of the present disclosure, filtered foreign substances or moisture may be discharged from the outside air introduction device, thereby preventing noise occurrence or deterioration of device performance, as well as improving quality and reliability of the product.

While examples have been shown and described above, it will be apparent to those skilled in the art that modifications and variations could be made without departing from the scope of the present disclosure as defined by the appended claims.

What is claimed is:

1. An apparatus for introducing outside air, the apparatus comprising:
a duct-shaped body;
at least one filter member configured to filter foreign substances or moisture from the outside air, wherein the at least one filter is disposed in the duct-shaped body; and
a discharger configured to discharge the filtered foreign substances or moisture, wherein the discharger is disposed in a lower portion of the duct-shaped body, and wherein the lower portion is closer to the ground.

2. The apparatus of claim 1, wherein the duct-shaped body comprises:
an inlet disposed on one side to allow outside air to flow in, wherein an inlet grill is mounted on the inlet;
an outlet disposed on another side; and
at least one partition dividing an internal space into a plurality of regions.

3. The apparatus of claim 2, wherein:
a first inclined surface is formed on a first surface of the duct-shaped body, and
the inlet is formed on the first inclined surface.

4. The apparatus of claim 2, wherein the at least one partition has a curved cross-section that is curved at least once.

5. The apparatus of claim 2, wherein:
a through-hole is formed in the middle of the at least one partition,
the filter member includes at least a first filter member, and
the first filter member is mounted in the through-hole.

6. The apparatus of claim 5, wherein the through-hole comprises a protrusion, and wherein the protrusion is formed by curving at least one edge of the through-hole.

7. The apparatus of claim 5, wherein:
a second inclined surface is formed on a second surface of the duct-shaped body,
the discharger is connected to an end of the second inclined surface, and
foreign substances or moisture filtered by the first filter member are guided to the discharger along the second inclined surface or the at least one partition and discharged to an outside of the duct-shaped body.

8. The apparatus of claim 5, wherein:
the filter member further comprises a second filter member, and
the second filter member is mounted on the outlet.

9. The apparatus of claim 8, wherein one end of the at least one partition is spaced apart from a surface of the duct-shaped body or the discharger to form a gap between the at least one partition and the surface of the duct-shaped body or the discharger, and
foreign substances or moisture filtered by the second filter member are guided to the discharger by the gap and discharged to an outside of the duct-shaped body.

10. The apparatus of claim 9, wherein a guide is formed in a portion of the at least one partition, and wherein a thickness of the guide is incrementally increased from one end of the guide to another end of the guide.

11. The apparatus of claim 10, wherein the guide has a triangular cross-section, and wherein the triangular cross-section has a shape of a triangle that is not a right triangle.

12. The apparatus of claim 8, wherein the second filter member is configured to filter foreign substances or moisture that are smaller in size than those filtered by the first filter member.

13. The apparatus of claim 8, wherein:
the first filter member comprises a mesh filter, and
the second filter member comprises a particle filter.

14. The apparatus of claim 1, wherein the discharger comprises:
a collection portion having an upper portion and a lower portion, wherein the upper portion has a wider shape than the lower portion;
a discharge port at the lower portion of the collection portion; and
a discharge pipe connected to the discharge port.

15. The apparatus of claim 1, wherein the apparatus is connected to a mixing chamber configured to provide a space for mixing the outside air and circulating indoor air.

16. The apparatus of claim 15, wherein the apparatus is provided as a pair, wherein:
a first one of the pair is connected to front of the mixing chamber and a second one of the pair is connected to rear of the mixing chamber, and
a circulation duct is connected to a portion of the mixing chamber, wherein the circulation duct is configured to allow the indoor air to flow into the mixing chamber.

17. The apparatus of claim 16, wherein:
a condenser is connected to one side of the mixing chamber,
an evaporator is connected to another side of the mixing chamber, and
blowers are disposed downstream of both the condenser and the evaporator.

18. The apparatus of claim 17, wherein each of the blowers interfaces with a pair of air supply portions, and wherein
each of the air supply portions comprises:
a first air supply duct,
a second air supply duct branched from the first air supply duct, and
a door disposed between the first air supply duct and the second air supply duct.

19. The apparatus of claim 18, wherein one of the first air supply ducts adjacent to the condenser and another of the first air supply ducts adjacent to the evaporator are connected to each other and integrated.

20. The apparatus of claim 1, wherein the discharger is configured to discharge the filtered foreign substances or moisture to reduce noise associated with an operation of the apparatus.
